(19) United States
(12) Patent Application Publication
(10) Pub. No.: US 2012/0217890 A1
(43) Pub. Date: Aug. 30, 2012

(54) DRIVING CIRCUIT FOR LED

(75) Inventors: Charles Chang, Hsinchu County (TW); Ronald Chang, Hsinchu County (TW)

(73) Assignee: HANERGY TECHNOLOGIES, INC., Hsinchu County (TW)

(21) Appl. No.: 13/370,474

(22) Filed: Feb. 10, 2012

(30) Foreign Application Priority Data
Feb. 24, 2011 (TW) 100106294

(51) Int. Cl. H05B 37/02

(52) U.S. Cl. 315/224; 315/245

(57) ABSTRACT

A driving circuit for driving a load is provided. The driving circuit includes a control module providing a control signal to adjust a load current flowing through the load; and a voltage clamping module providing a power voltage to the control module.

### CROSS-REFERENCE TO RELATED APPLICATION AND CLAIM OF PRIORITY

The application claims the benefit of Taiwan Patent Application No. 100106294, filed on Feb. 24, 2011, in the Taiwan Intellectual Property Office, the disclosures of which are incorporated herein in their entirety by reference.

### FIELD OF THE INVENTION

The present invention relates to a driving circuit, and more particularly to a driving circuit for the LED.

### BACKGROUND OF THE INVENTION

The LED is a common electronic element. At first, the LED only serves as the red pilot lamp. Then, the yellow-light LED, the orange-light LED, the green-light LED and the blue-light LED appear, which greatly expand the application range of the LED. Currently, the LED can be used for the traffic light, the lamp, the wall lamp, the LED array fluorescent lamp, etc. When the current is very low (approximately smaller than 20 mA), it is simpler to drive a single LED or a plurality of LEDs. When the power loss is not considered, the driving circuit can be achieved by using a simple linear regulator or a current-limiting resistor, wherein the current-limiting resistor can prevent the LED from burnout due to an excessively large current. However, a high-efficiency switching regulation circuit is usually used to prevent the power loss. LEDs connected in series also raise the variation range of the driving voltage, which increases the difficulty in designing the driving circuit.

The LED is a stable luminary, which can achieve a good and precise radiating color and intensity by providing a stable current and can reduce the rising temperature due to the energy consumption. Besides, the LED can meet the requirement of the green environmental protection and the electrical standards such as EN60598 of CE, EN61347 and EN60825. The driving circuit for the LED includes a control module. The control module includes a reference voltage, a current-sensing comparator, a ramp signal, an RS flip-flop, an oscillator and an LED driving gate. One important LED driving characteristic is the light-adjusting ability. The reference voltage and the ramp signal which is added with a feedback signal are input to the current-sensing comparator. The output signal from the current-sensing comparator and the signal from the oscillator are input to the RS flip-flop. The output signal from the RS flip-flop is input to the LED driving gate. The sensing current of the LED is controlled by the output signal from the LED driving gate, thereby determining the brightness of the LED.

A BUCK topology power supply includes the above-mentioned driving circuit for the LED, which can realize the current driving for the large-power LED and the array LED. Conventionally, for saving energy, a triac dimmer is disposed at the AC input terminal of the driving circuit for the LED to decrease the energy of the input wave. However, during the period when the energy of the input wave is decreased, the control module of the driving circuit for the LED is periodically at a low potential, which makes the elements therein unable to be operated. That is, it is important to enable the control module of the driving circuit for the LED to be at a high potential any time, without being affected by the variation of the input voltage source. Moreover, this buck topology also can use “the operation of fixing the turn-off time”. That is, the oscillator can start to count a fixed period when the output of the current-sensing comparator is rising. Besides, the ramp signal which is added with a current-sensing voltage, i.e. the feedback signal, can ease off the oscillation due to the operation at a fixed frequency.

In order to overcome the drawbacks in the prior art, a driving circuit for the LED is provided. The particular design in the present invention not only solves the problems described above, but also is easy to be implemented. Thus, the present invention has the utility for the industry.

### SUMMARY OF THE INVENTION

The present invention provides a method for driving the LED, which can drive the LED simply and efficiently, and is quite beneficial for the popularization of the LED.

The present invention provides a driving circuit for the LED, which provides a stable voltage source to the control module of the driving circuit, thereby enabling a stable operation of the driving circuit. The present invention can constantly provide the power voltage to the control module of the driving circuit for the LED, which is beneficial for the popularization of the driving circuit for the LED.

In accordance with an aspect of the present invention, a driving circuit for driving a load is provided. The driving circuit includes a control module providing a control signal to adjust a load current flowing through the load; and a voltage clamping module providing a power voltage to the control module.

In accordance with another aspect of the present invention, a driving circuit is provided. The driving circuit includes a control module; and a voltage clamping module providing a power voltage to the control module.

In accordance with a further aspect of the present invention, a driving circuit is provided. The driving circuit includes a control module; and a constant voltage source providing a power voltage to the control module.

In accordance with further another aspect of the present invention, a driving circuit is provided. The driving circuit includes a control module; and a voltage source providing a power voltage to the control module to decrease a loss of the driving circuit.

The present invention not only stabilizes the operation of the control module of the driving circuit, but also enhances the brightness of the LED and prolongs the life thereof.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a driving circuit for the LED according to a first embodiment of the present invention; and

FIG. 2 shows a driving circuit for the LED according to a second embodiment of the present invention.

### DETAILED DESCRIPTION OF EMBODIMENTS

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

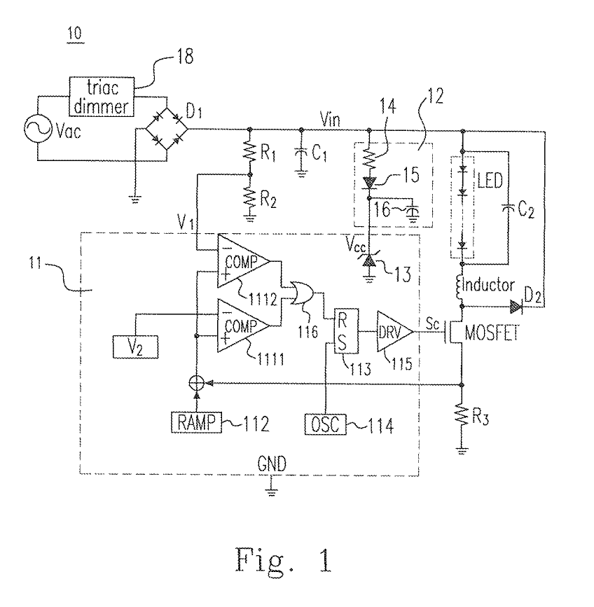

Please refer to FIG. 1, which shows a driving circuit 10 for the LED according to a first embodiment of the present invention. The driving circuit 10 includes a control module 11 and a voltage clamping module 12. The control module 11 provides a control signal S_{c} to adjust a load current flowing through a load. The voltage clamping module 12 provides a power voltage V_{cc} to the control module 11. The control module 11 includes a first comparator 1111, a second comparator 1112, a ramp signal 112, an OR gate 116, an RS flip-flop 113, an oscillator 114 and a driving gate 115. The voltage clamping module 12 includes a Zener diode 13, a resistor 14, a first diode 15 and a capacitor 16. The Zener diode 13 serves as a voltage source to provide a constant voltage function. The first diode 15 is connected to the resistor 14 and the Zener diode 13. The capacitor 16 is connected to the first diode 15, and provides the power voltage V_{cc} to the control module 11 when there is no input voltage inputted to the driving circuit 10. The driving circuit 10 further includes a triac dimmer 18 for adjusting the waveform of an input signal.

The Zener diode 13 determines the power voltage V_{cc} provided to the control module 11. The resistor 14 limits the current flowing through the control module 11. The capacitor 16 decouples the driving circuit 10. The control module 11 performs the power factor correction function. Besides, when the triac dimmer 18 turns off the input signal, the first diode 15 prevents the loss of the power voltage V_{cc}. Generally, such way of adding a stable power voltage V_{cc} to the control module 11 of the driving circuit 10 can be applied to a buck circuit topology, a buck-boost circuit topology or a floating ground buck circuit topology.

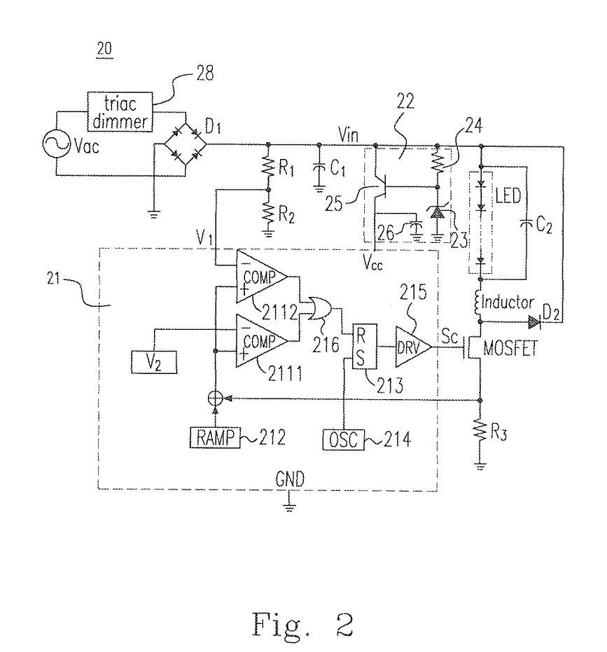

Please refer to FIG. 2, which shows a driving circuit 20 for the LED according to a second embodiment of the present invention. The driving circuit 20 includes a control module 21 and a voltage clamping module 22. The control module 21 provides a control signal S_{c} to adjust a load current flowing through a load. The voltage clamping module 22 provides a power voltage V_{cc} to the control module 21. The control module 21 includes a first comparator 2111, a second comparator 2112, a ramp signal 212, an OR gate 216, an RS flip-flop 213, an oscillator 214 and a driving gate 215. The voltage clamping module 22 includes a Zener diode 23, a resistor 24, a bipolar junction transistor 25 and a capacitor 26. The Zener diode 23 serves as a voltage source to provide a constant voltage function. The bipolar junction transistor 25 is connected to the resistor 24 and the Zener diode 23. The capacitor 26 is connected to the bipolar junction transistor 25, and provides the power voltage V_{cc} to the control module 21 when there is no input voltage inputted to the driving circuit 20. The driving circuit 20 further includes a triac dimmer 28 for adjusting the waveform of an input signal.

The Zener diode 23 determines the power voltage V_{cc} provided to the control module 21. The resistor 24 limits the current flowing through the control module 21. The capacitor 26 decouples the driving circuit 20. The control module 21 performs the power factor correction function. Besides, when the triac dimmer 28 turns off the input signal, the bipolar junction transistor 25 prevents the loss of the power voltage V_{cc}. Generally, such way of adding a stable power voltage V_{cc} to the control module 21 of the driving circuit 20 can be applied to a buck circuit topology, a buck-boost circuit topology or a floating ground buck circuit topology.

The present invention compensates the shortcomings of the prior art by providing the voltage clamping modules 12, 22. The driving circuit 10 of FIG. 1 provides the stable power voltage V_{cc} to the control module 11 thereof, and the driving circuit 20 of FIG. 2 provides the stable power voltage V_{cc} to the control module 21 thereof

The addition of the stable power voltage V_{cc} to the control module 11, 21 of the driving circuit 10, 20 can be applied to different control modules of the driving circuits and different driving topologies for the LED. The present invention performs the power factor correction function to enhance the utilization rate of the electrical energy, and reduces the noise and increases the performance of the circuit by adding the feedback signal, thereby reducing the rising temperature due to the energy consumption and enhancing the ability of anti-electromagnetic interference. The present invention can convert the AC power into the DC power for driving the large-power LED and the array LED by adding the stable power voltage V_{cc} to the control module 11, 21 of the driving circuit 10, 20, which can not only achieve a good and precise radiating color and intensity by enhancing the reliability of the driving signal, but also be applied to the LED array fluorescent lamp and other photoelectric light-emitting elements driven in a circuit-driving way. Moreover, the present invention can also enhance the efficiency of the driving circuit 10, 20 and achieve the goal of saving energy.

### Embodiments

1. A driving circuit for driving a load, comprising:
a control module providing a control signal to adjust a load current flowing through the load; and
a voltage clamping module providing a power voltage to the control module.

2. The driving circuit of Embodiment 1, wherein the voltage clamping module comprises:
a Zener diode serving as a voltage source to provide a constant voltage function;
a resistor;
a first diode connected to the resistor and the Zener diode; and
a capacitor connected to the first diode, and providing the power voltage to the control module when there is no input voltage inputted to the driving circuit.

3. The driving circuit of any one of Embodiments 1-2, wherein the Zener diode determines the power voltage provided to the control module.

4. The driving circuit of any one of Embodiments 1-3, wherein the resistor limits a current flowing through the control module.

5. The driving circuit of any one of Embodiments 1-4, wherein the capacitor decouples the driving circuit.

6. The driving circuit of any one of Embodiments 1-5, further comprising:
a triac dimmer adjusting a waveform of an input signal.

7. The driving circuit of any one of Embodiments 1-6, wherein when the triac dimmer turns off the input signal, the first diode prevents a loss of the power voltage.

8. The driving circuit of any one of Embodiments 1-7, wherein the first diode is replaced with a bipolar junction transistor.

9. The driving circuit of any one of Embodiments 1-8, wherein the control module performs a power factor correction function.

10. The driving circuit of any one of Embodiments 1-9, wherein the load is an LED.

11. The driving circuit of any one of Embodiments 1-10, being applied to one selected from a group consisting of a buck circuit topology, a buck-boost circuit topology and a floating ground buck circuit topology.

12. A driving circuit, comprising:
a control module; and
a voltage clamping module providing a power voltage to the control module.

13. The driving circuit of Embodiment 12, wherein the voltage clamping module comprises:
a Zener diode determining the power voltage provided to the control module;
a resistor limiting a current flowing through the control module;
a first diode connected to the resistor and the Zener diode; and
a capacitor connected to the first diode, and providing the power voltage to the control module when there is no input voltage inputted to the driving circuit.

14. The driving circuit of any one of Embodiments 12-13, further comprising:
a triac dimmer adjusting a waveform of an input signal.

15. The driving circuit of any one of Embodiments 12-14, wherein when the triac dimmer turns off the input signal, the first diode prevents a loss of the power voltage.

16. The driving circuit of any one of Embodiments 12-15, wherein the first diode is replaced with a bipolar junction transistor.

17. A driving circuit, comprising:
a control module; and
a constant voltage source providing a power voltage to the control module.

18. The driving circuit of Embodiment 17, wherein the constant voltage source comprises:
a Zener diode determining the power voltage provided to the control module;
a resistor limiting a current flowing through the control module;
a first diode connected to the resistor and the Zener diode; and
a capacitor connected to the first diode, and providing the power voltage to the control module when there is no input voltage inputted to the driving circuit.

19. A driving circuit, comprising:
a control module; and
a voltage source providing a power voltage to the control module to decrease a loss of the driving circuit.

20. The driving circuit of Embodiment 19, wherein the voltage source comprises:
a Zener diode determining the power voltage provided to the control module;
a resistor limiting a current flowing through the control module;
a first diode connected to the resistor and the Zener diode; and
a capacitor connected to the first diode, and providing the power voltage to the control module when there is no input voltage inputted to the driving circuit.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A driving circuit for driving a load, comprising:
a control module providing a control signal to adjust a load current flowing through the load; and
a voltage clamping module providing a power voltage to the control module.

2. A driving circuit as claimed in claim 1, wherein the voltage clamping module comprises:
a Zener diode serving as a voltage source to provide a constant voltage function;
a resistor;
a first diode connected to the resistor and the Zener diode; and
a capacitor connected to the first diode, and providing the power voltage to the control module when there is no input voltage inputted to the driving circuit.

3. A driving circuit as claimed in claim 2, wherein the Zener diode determines the power voltage provided to the control module.

4. A driving circuit as claimed in claim 2, wherein the resistor limits a current flowing through the control module.

5. A driving circuit as claimed in claim 2, wherein the capacitor decouples the driving circuit.

6. A driving circuit as claimed in claim 2, further comprising:
a triac dimmer adjusting a waveform of an input signal.

7. A driving circuit as claimed in claim 6, wherein when the triac dimmer turns off the input signal, the first diode prevents a loss of the power voltage.

8. A driving circuit as claimed in claim 7, wherein the first diode is replaced with a bipolar junction transistor.

9. A driving circuit as claimed in claim 1, wherein the control module performs a power factor correction function.

10. A driving circuit as claimed in claim 1, wherein the load is an LED.

11. A driving circuit as claimed in claim 1, being applied to one selected from a group consisting of a buck circuit topology, a buck-boost circuit topology and a floating ground buck circuit topology.

12. A driving circuit, comprising:
a control module; and
a voltage clamping module providing a power voltage to the control module.

13. A driving circuit as claimed in claim 12, wherein the voltage clamping module comprises:
a Zener diode determining the power voltage provided to the control module;
a resistor limiting a current flowing through the control module;
a first diode connected to the resistor and the Zener diode; and
a capacitor connected to the first diode, and providing the power voltage to the control module when there is no input voltage inputted to the driving circuit.

14. A driving circuit as claimed in claim 13, further comprising:
a triac dimmer adjusting a waveform of an input signal.

15. A driving circuit as claimed in claim 14, wherein when the triac dimmer turns off the input signal, the first diode prevents a loss of the power voltage.

16. A driving circuit as claimed in claim 15, wherein the first diode is replaced with a bipolar junction transistor.

17. A driving circuit, comprising:
a control module; and
a constant voltage source providing a power voltage to the control module.

18. A driving circuit as claimed in claim 17, wherein the constant voltage source comprises:
a Zener diode determining the power voltage provided to the control module;
a resistor limiting a current flowing through the control module;
a first diode connected to the resistor and the Zener diode; and
a capacitor connected to the first diode, and providing the power voltage to the control module when there is no input voltage inputted to the driving circuit.

19. A driving circuit, comprising:
a control module; and
a voltage source providing a power voltage to the control module to decrease a loss of the driving circuit.

20. A driving circuit as claimed in claim 19, wherein the voltage source comprises:
a Zener diode determining the power voltage provided to the control module;
a resistor limiting a current flowing through the control module;
a first diode connected to the resistor and the Zener diode; and
a capacitor connected to the first diode, and providing the power voltage to the control module when there is no input voltage inputted to the driving circuit.
